(19) United States
(12) Patent Application Publication
(10) Pub. No.: US 2020/0264604 A1
(43) Pub. Date: Aug. 20, 2020

(54) UNMANNED AERIAL VEHICLE SYSTEM, AND COMMUNICATION METHOD AND REMOTE CONTROL DEVICE THEREFOR

(71) Applicant: SZ DJI TECHNOLOGY CO., LTD., Shenzhen (CN)

(72) Inventors: Ye TAO, Shenzhen (CN); Haiwang DUAN, Shenzhen (CN); Chuyue AI, Shenzhen (CN)

(21) Appl. No.: 16/869,283

(22) Filed: May 7, 2020

Related U.S. Application Data
(63) Continuation of application No. PCT/CN2017/113981, filed on Nov. 30, 2017.

(51) Int. Cl. G05D 1/00; G08C 17/02; H04W 12/00; B64C 39/02

(52) U.S. Cl. CPC G05D 1/0038; G08C 17/02; B64C 2201/146; B64C 39/024; H04W 12/001

(57) ABSTRACT

The present disclosure provides an unmanned aerial vehicle (UAV) system. The UAV system includes a first remote control device, a second remote control device, a UAV, and a functional device mounted on the UAV. The first remote control device is configured to send remote control information to control the UAV, and the second remote control device is configured to send remote control information to control the functional device. The first remote control device and the second remote control device are communicatively connected to form a communication link, and the first remote control device and the second remote control device exchange interactive data based on the communication link. The interactive data at least include text data or audio data.

### CROSS-REFERENCE TO RELATED APPLICATION

This application is a continuation of International Application No. PCT/CN2017/113981, filed Nov. 30, 2017, the entire content of which is incorporated herein by reference.

### TECHNICAL FIELD

The present disclosure generally relates to the field of unmanned aerial vehicle (UAV) communication technologies and, more particularly, relates to a UAV system and a communication method thereof, and a remote control device applied to the UAV system.

### BACKGROUND

Unmanned aerial vehicles (UAVs) are being developed rapidly, and the areas of applications of UAVs include public security, urban management, agriculture, geology, meteorology, electricity, rescue and disaster relief, video recording, etc. UAVs generally carry loads when performing tasks. For example, a UAV for aerial photography may be equipped with a gimbal and a gimbal camera for video recording, and may be used for road monitoring, power inspection, street view capturing, etc. In another example, a UAV for plant protection may be equipped with a pesticide tank, a spray device, and/or a monitoring device for farmland pesticide treatment or data collection. Also for example, a UAV for environmental protection may be equipped with an environmental monitoring device for monitoring the conditions of air, soil, water, etc., and also for quickly tracking and monitoring the development of emergent environmental pollution incidents in real time. In these application areas, while the operator remotely controls the UAV, sometimes it requires to remotely control the load as well. Therefore, a dual-remote UAV system has been developed, such that two operators may be able to respectively control the UAV and the load remotely to achieve desired control accuracy.

However, the existing technology may still have certain problems. When two operators are far away from each other while performing a dual-remote operation, the operators of the two remote controllers may need to communicate with each other in real time. According to current communication methods, short-range communication devices such as walkie-talkies may be used for communication, or third-party applications installed on mobile devices may be used for communication based on cellular data communication. However, when using walkie-talkies, the frequency band of the walkie-talkie may interfere with the frequency band of the UAV, causing the control signal when the UAV performs operations may be affected, and thus the operation of the UAV may be affected. When using third-party applications of mobile devices for communication based on cellular data communication, not only the complexity of the operation of the UAV system may be increased, but an additional communication cost may apply. Especially, when the communication signal is poor in the field, communication may often fail.

### SUMMARY

One aspect of the present disclosure provides an unmanned aerial vehicle (UAV) system. The UAV system includes a first remote control device, a second remote control device, a UAV, and a functional device mounted on the UAV. The first remote control device is configured to send remote control information to control the UAV, and the second remote control device is configured to send remote control information to control the functional device. The first remote control device and the second remote control device are communicatively connected to each other to form a communication link, and the first remote control device and the second remote control device exchange interactive data based on the communication link. The interactive data at least include text data or audio data.

Another aspect of the present disclosure provides a communication method for a UAV system. The UAV system includes a first remote control device, a second remote control device, a UAV, and a functional device mounted on the UAV. The communication method includes establishing a communication connection between the first remote control device and the UAV, establishing a communication connection between the second remote control device and the functional device, and establishing a communication connection between the first remote control device and the second remote control device. The first remote control device sends remote control information to control the UAV. The second remote control device sends remote control information to control the functional device. The communication method also includes the first remote control device sending interactive data to the second remote control device, and receiving interactive data sent by the second remote control device. The interactive data includes at least one type of text data or video data.

Another aspect of the present disclosure provides a remote control device for a UAV system. The remote control device includes a data acquisition unit, a data processing unit, a communication unit, and an output unit. The remote control device communicates with another remote control device through the communication unit. The data acquisition unit is configured to collect interactive data. The interactive data includes at least one type of text data or video data. The data processing unit is configured to perform packet processing on the interactive data collected by the data acquisition unit. The communication unit is configured to send the interactive data packet-processed by the data processing unit to the another remote control device. The communication unit is further configured to receive interactive data sent by the another remote control device. The data processing unit is further configured to parse the interactive data received by the communication unit. The output unit is configured to output the interactive data parsed by the data processing unit.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions in various embodiments of the present disclosure, the drawings used in the description of the embodiments will be briefly described below. It is obvious that the drawings in the following description are some embodiments of the present disclosure, and for those of ordinary skill in the art, other drawings may also be obtained according to these drawings without creative effort.

FIG. 1 illustrates a structural block diagram of an exemplary UAV system according to various embodiments of the present disclosure;

FIG. 2 illustrates a structural block diagram of another exemplary UAV system according to various embodiments of the present disclosure;

FIG. 3 illustrates a structural block diagram of another exemplary UAV system according to various embodiments of the present disclosure;

FIG. 4 illustrates a structural block diagram of another exemplary UAV system according to various embodiments of the present disclosure;

FIG. 5 illustrates a schematic flowchart of an exemplary communication method of a UAV system according to various embodiments of the present disclosure; and

FIG. 6 illustrates a structural block diagram of an exemplary remote control device according to various embodiments of the present disclosure.

### DETAILED DESCRIPTION

In the following, the technical solutions in various embodiments of the present disclosure will be described with reference to the accompanying drawings. It is obvious that the described embodiments are only a part of various embodiments of the present disclosure, but not all the embodiments. Other embodiments obtained by those skilled in the art based on various embodiments of the present disclosure without creative efforts are within the scope of the present disclosure.

It should be noted that when a component is referred to as being “fixed” to another component, it can be directly on the other component or an intermediate component may be present. When a component is considered as “connected to” another component, it can be directly connected to another component or both may be connected to an intermediate component.

All technical and scientific terms used herein have the same meaning as commonly understood by one of ordinary skill in the art to which this disclosure belongs, unless otherwise defined. The terminology used in the description of the present disclosure is for the purpose of describing particular embodiments and is not intended to limit the disclosure. The term “and/or” used herein includes any and all combinations of one or more of the associated listed items.

Some embodiments of the present disclosure are described in detail below with reference to the accompanying drawings. The features of the embodiments and examples described below can be combined with each other without conflict.

In order to enable those skilled in the art to better understand the technical schemes of the present disclosure, the technical solutions in various embodiments of the present disclosure will be clearly and completely described below with reference to the drawings. Unless defined otherwise, all technical and scientific terms used herein have the same meaning as commonly understood by one of ordinary skill in the art to which this disclosure belongs. The terminology used herein in the description of the present disclosure is merely for the purpose of describing specific embodiments, and is not intended to limit the present disclosure. The terms “first”, “second”, and the like in the description and claims of the present disclosure and the above-mentioned drawings are used to distinguish different objects and are not used to describe a specific order. In addition, the terms “including” and “comprising” and any variations thereof are intended to cover non-exclusive inclusion. For example, a process, method, system, product, or device containing a series of steps or units is not limited to the listed steps or units, but optionally also includes steps or units that are not listed, or optionally also includes other steps or units inherent to the process, method, product, or device.

Reference to “one embodiment” herein means that a particular feature, structure, or characteristic described in connection with the embodiment may be included in at least one embodiment of the present disclosure. The appearances of this phrase in various places in the specification are not necessarily all referring to the same embodiment, nor are they independent or alternative embodiments that are mutually exclusive with other embodiments. It should be explicitly and implicitly understood by those skilled in the art that the embodiments described herein may be combined with other embodiments.

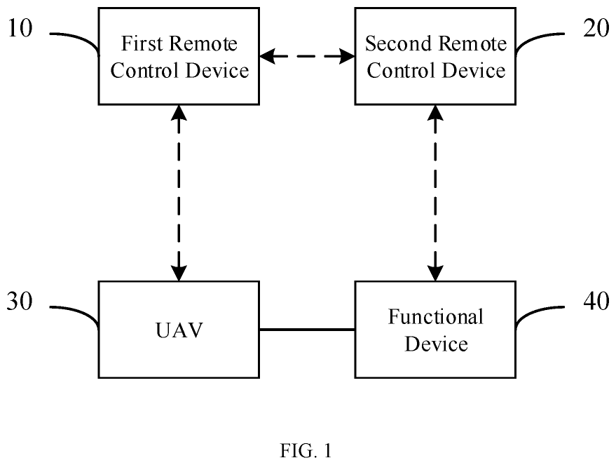

The present disclosure provides an unmanned aerial vehicle (UAV) system. FIG. 1 illustrates a structural block diagram of an exemplary UAV system according to various embodiments of the present disclosure. Referring to FIG. 1, the UAV system may include a first remote control device 10, a second remote device 20, a UAV 30, and a functional device 40 mounted on the UAV 30.

The first remote control device 10 may be communicatively connected with the UAV 30, and may be configured to send remote control information to control the UAV. The second remote control device 20 may be communicatively connected to the functional device 40, and may be configured to send remote control information to control the functional device 40. In one embodiment, the communication connection between the second remote control device 20 and the functional device 40 may be a direct communication connection. In some other embodiments, the communicative connection between the second remote control device 20 and the functional device 40 may be achieved by communicatively connecting the second remote control device 20 and the UAV 30, and communicatively/electrically connecting the UAV 30 and the functional device 40. In other embodiments, the communication connection between the second remote control device 20 and the functional device 40 may be achieved by communicatively connecting the first remote control device 10 and the UAV 30, and connecting the second remote control device 20 and the functional device 40 through the first remote control device 10, or connecting the second remote control device 20 and the UAV 30 through the first remote control device 10, and communicatively/electrically connecting the UAV 30 and the functional device 40.

The first remote control device 10 and the second remote control device 20 may be communicatively connected to each other to form a communication link. The first remote control device 10 and the second remote control device 20 may exchange interactive data based on the communication link. The interactive data may at least include text data or audio data. The communication frequency band that the first remote control device and the second remote control device use to send remote control information may be different from the communication frequency band that the first remote control device and the second remote control device use to exchange interactive data. For example, the first remote control device 10 and the second remote control device 20 may operate in a communication frequency band corresponding to 2.4 GHz when sending remote control information, and the first remote control device 10 and the second remote control device 20 may operate in a communication frequency band corresponding to 5.8 GHz when sending and receiving interactive data. Alternatively, the first remote control device 10 and the second remote control device 20 may operate in a communication frequency band corresponding to 5.8 GHz when sending remote control information, and the first remote control device 10 and the second remote control device 20 may operate in a communication frequency band corresponding to 2.4 GHz when sending and receiving interactive data.

In one embodiment, since the communication link formed by the first remote control device 10 and the second remote control device 20 is independent of other communication links, it can be directly used for the mutual transmission of interactive data between the first remote control device 10 and the second remote control device 20. As such, the two-way communication between the remote control device 10 and the second remote control device 20 may be realized without affecting the remote control signal. In addition, the security and privacy of data transmission may be ensured, and third-party applications of mobile devices based on cellular data communication may not be necessary, thereby avoiding additional costs, and reducing the complexity of the UAV system. As such, even when the signal of the cellular data communication is poor, real time two-way communication between the first control device 10 and the second control device 20 may still be achieved.

In one embodiment, the first remote control device 10 that controls the UAV 30 may be a primary control device, and the second remote control device 20 that controls the functional device 40 may be a secondary control device. For example, the UAV system may include a primary control device, and at the same time, the UAV system may also include one or more secondary control devices. In some embodiments, the primary control device and the secondary control devices may be interchangeable.

In some embodiments, the first remote control device 10, a controlled device, and the second remote control device 20 may be communicatively connected in sequence to form another communication link. The controlled device may be the UAV 30 and/or the functional device 40. The first remote control device 10 and the second remote control device 20 may also exchange interactive data based on the another communication link. For example, the first remote control device 10 may send the interactive data to the controlled device. After identifying the recipient of the interactive data, the controlled device may send the interactive data to the identified recipient. The interactive data may be sent separately from the remote control information. Alternatively, the interactive data may be included in the remote control information and sent to the controlled device together. The controlled device may read the interactive data included in the remote control information and send the interactive data to the identified recipient. As such, the controlled device may be used as a relay communication station to realize mutual exchange of the interactive data between the first remote control device 10 and the second remote control device 20.

In some embodiments, each of the first remote control device 10 and the second remote control device 20 may be a remote controller with an interactive interface and an operation handle, a mobile terminal with an interactive interface, or a combination of a mobile terminal with an interactive interface and a remote controller with an operation handle. The mobile terminal with an interactive interface may be a mobile phone, a tablet computer, or any other mobile electronic device with a communication module.

In one embodiment, each of the first remote control device 10 and the second remote control device 20 may be a combination of a mobile terminal with an interactive interface and a remote controller with an operation handle. The mobile terminal and the remote controller may be connected wirelessly or may be connected through a universal serial bus (USB), and the two remote controllers may be connected via Wi-Fi.

In some embodiments, the UAV 30 may be any of an unmanned aircraft, an unmanned ship or a driverless car. For example, the disclosed UAV system, communication method, and remote control device are not limited to unmanned aircrafts that are illustrated as examples in the present disclosure. Additionally, the functional device 40 may be a gimbal and/or a camera, a spraying device, or an environmental monitoring device. That is, although the UAV is used as an example to describe the present disclosure, other types of vehicles may also be used.

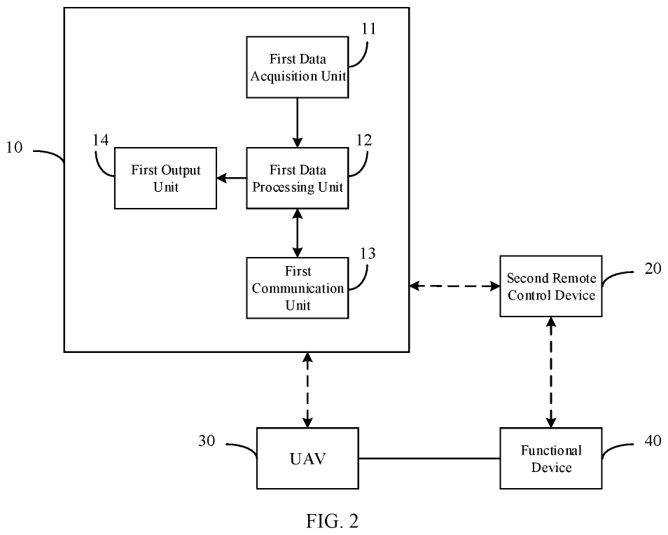

FIG. 2 illustrates a structural block diagram of another exemplary UAV system according to various embodiments of the present disclosure. Referring to FIG. 2, in some embodiments of the present disclosure, the first remote control device 10 may include a first data acquisition unit 11, a first data processing unit 12, a first communication unit 13, and a first output unit 14.

The first data acquisition unit 11 may be configured to collect interactive data and send the collected interactive data to the first data processing unit 12. In one embodiment, the collected interactive data may also be sent to a storage unit (not shown) of the first remote control device 10 for backup storage. The first data processing unit 12 may be configured to perform packet processing on the interactive data collected by the first data acquisition unit 11, and send the packet-processed interactive data to the first communication unit 13. The first communication unit 13 may be configured to send the interactive data, packet-processed by the first data processing unit 12, to the second remote control device 20. In one embodiment, the first communication unit 13 may be a wireless communication module, such as a Wi-Fi module.

Further, the first communication unit 13 may also be configured to receive the interactive data sent by the second remote control device 20. In some embodiments, when receiving the interactive data sent by the second remote control device 20, the first communication unit 13 may verify the received interactive data to ensure the accuracy and completeness of the received interactive data. Further, the first data processing unit 12 may also be configured to parse the interactive data received by the first communication unit 13; the first output unit 14 may be configured to output the interactive data parsed by the first data processing unit 12. For example, the first output unit 14 may output the interactive data in a form of audio playback or visual display.

In some embodiments of the present disclosure, when the first remote control device 10 is a combination of a mobile terminal with an interactive interface and a remote controller with an operation handle, the mobile terminal may include the first data acquisition unit 11 while the remote controller may include the first data processing unit 12 and the first communication unit 13, and the interactive data collected by the mobile terminal may be transparently sent to the remote controller for further operations. Alternatively, the mobile terminal may include the first data acquisition unit 11 and the first data processing unit 12 while the remote controller may include the first communication unit 13, and the mobile terminal may collect interactive data and process the data, and then transparently send the data to the remote controller for further operations. The first output unit 14 may be disposed on the mobile terminal, on the remote controller, or on both the mobile terminal and remote controller.

In some embodiments of the present disclosure, the first data processing unit 12 may be further configured to perform an encryption operation on the interactive data collected by the first data acquisition unit 11 and a decryption operation on the interactive data received by the first communication unit 13. By encrypting the interactive data, the security and privacy of data transmission may be further ensured.

In some embodiments of the present disclosure, the first communication unit 13 may be further configured to identify a recipient of the interactive data, packet-processed by the first data processing unit 12, and when the identified recipient is the second remote control device 20, send the interactive data, packet-processed by the first data processing unit 12, to the second remote control device 20. When there are multiple recipients, by identifying the recipients, directed data transmission may be realized. In one embodiment, the recipient may be the secondary control device, the controlled UAV 30, or the functional device 40 described in the embodiments provided above.

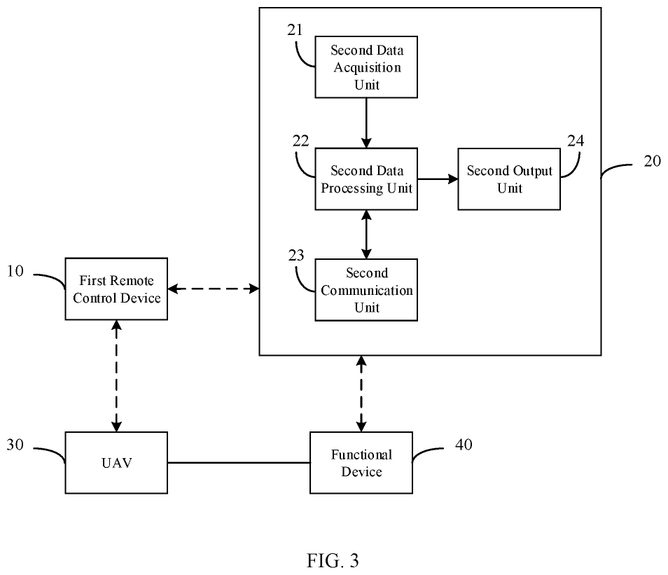

FIG. 3 illustrates a structural block diagram of another exemplary UAV system according to various embodiments of the present disclosure. Referring to FIG. 3, in some embodiments of the present disclosure, the second remote control device 20 may include a second data acquisition unit 21, a second data processing unit 22, a second communication unit 23, and a second output unit 24.

The second data acquisition unit 21 may be configured to collect interactive data and send the collected interactive data to the second data processing unit 22. In one embodiment, the collected interactive data may also be sent to a storage unit (not shown) of the second remote control device 20 for backup storage. The second data processing unit 22 may be configured to perform packet processing on the interactive data collected by the second data acquisition unit 21, and send the packet-processed interactive data to the second communication unit 23. The second communication unit 23 may be configured to send the interactive data, packet-processed by the second data processing unit 22, to the first remote control device 10. In one embodiment, the second communication unit 23 may be a wireless communication module, such as a Wi-Fi module.

Further, the second communication unit 23 may also be configured to receive the interactive data sent by the first remote control device 10. In some embodiments, when receiving the interactive data sent by the first remote control device 10, the second communication unit 23 may verify the received interactive data to ensure the accuracy and completeness of the received interactive data. Further, the second data processing unit 22 may also be configured to parse the interactive data received by the second communication unit 23; the second output unit 24 may be configured to output the interactive data parsed by the second data processing unit 22. For example, the second output unit 24 may output the interactive data in a form of audio playback or visual display.

In some embodiments of the present disclosure, when the second remote control device 20 is a combination of a mobile terminal with an interactive interface and a remote controller with an operation handle, the mobile terminal may include the second data acquisition unit 21 while the remote controller may include the second data processing unit 22 and the second communication unit 23, and the interactive data collected by the mobile terminal may be transparently sent to the remote controller for further operations. Alternatively, the mobile terminal may include the second data acquisition unit 21 and the second data processing unit 22 while the remote controller may include the second communication unit 23, and the mobile terminal may collect interactive data and process the data, and then transparently send the data to the remote controller for further operations. The second output unit 24 may be disposed on the mobile terminal, on the remote controller, or on both the mobile terminal and remote controller.

In some embodiments of the present disclosure, the second data processing unit 22 may be further configured to perform an encryption operation on the interactive data collected by the second data acquisition unit 21 and a decryption operation on the interactive data received by the second communication unit 23. By encrypting the interactive data, the security and privacy of data transmission may be further ensured.

In some embodiments of the present disclosure, the second communication unit 23 may be further configured to identify a recipient of the interactive data, packet-processed by the second data processing unit 22, and when the identified recipient is the first remote control device 10, send the interactive data, packet-processed by the second data processing unit 22, to the first remote control device 10. When there are multiple recipients, by identifying the recipients, directed data transmission may be realized. In one embodiment, the recipient may be the secondary control device, the controlled UAV 30, or the functional device 40 described in the embodiments provided above.

Further, in the above embodiments of the present disclosure, the first data acquisition unit 11 and the second data acquisition unit 21 may be a camera device and/or a voice acquisition device such as a microphone.

Further, in the above embodiments of the present disclosure, the first output unit 14 and the second output unit 24 may be a speaker, a display device, or a combination of a speaker and a display device. The first output unit 14 and the second output unit 24 may display pictures, text, interface operations, and play audio and video.

In the above embodiments of the present disclosure, after the interactive data is processed through packet processing, a data packet including a packet header, an extended packet header, and a packet body may be generated. The packet header may include size information, version information, and header check information of the data packet; the extended packet header may include types of the sender and the recipient of the data packet, a command set, and a command identifier (ID); the packet body may be the interactive data itself or the encrypted interactive data. In the extension header, the types of the sender and the recipient may mainly define the hardware source and the receiving flow direction of the packet sent.

For example, when packet processing the interactive data, the first data processing unit 12 may define the first remote control device 10 as the sender and the second remote control device 20 as the recipient in the extension header. The command set and the command ID may be used to determine the type of the interactive data. For example, the command set may be a communication command set, a camera command set, a battery command set, etc. In one embodiment, the communication command set may include the structure and the format defining the interactive data, and the command ID may be a certain instruction in a command set.

In various embodiments of the present disclosure, the interactive data may include one or more types of text data, graphic data, audio data, video data, and operation data. The data generated when operations are performed on the operation interfaces of the first remote control device 10 and the second remote control device 20 may be the operation data, for example, when an gimbal-control operation is performed using a virtual joystick on the operation interface of the first remote control device 10, operation data such as the directional angle and the moving distance as the virtual joystick moves on the interface may be collected and then sent to the second remote control device 20 after packet processing. The operation data may be synchronized on the operation interface of the second remote control device 20 such that operation synchronization can be achieved between the first remote control device 10 and the second remote control device 20. In one embodiment, the interactive data after packet processing may also include packet body verification information, such that the first remote control device 10 and the second remote control device 20 may be able to perform data verification according to the packet body verification information when receiving the interactive data to ensure the accuracy and completeness of the received interactive data.

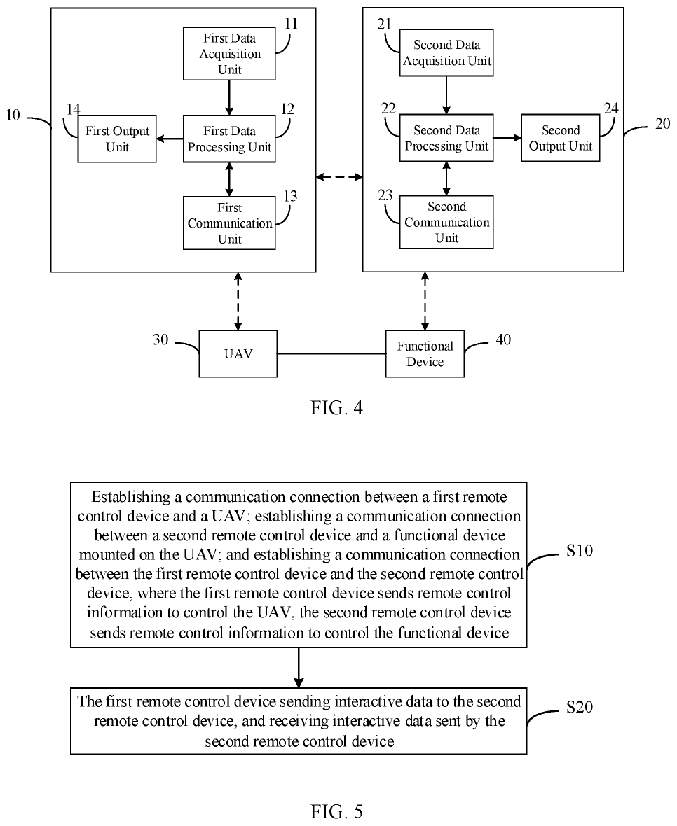

FIG. 4 illustrates a structural block diagram of another exemplary UAV system according to various embodiments of the present disclosure.

In the following, referring to FIG. 4, transmission of audio data will be taken as an example for further illustration. In one embodiment, the first remote control device 10 may send audio data to the second remote control device 20. The first data acquisition unit 11 may collect the audio data, and the audio data may be an audio data stream. The first data processing unit 12 may perform packet processing on the audio data and then send the packet-processed audio data to the first communication unit 13. After being packet processed by the first communication unit 13, the audio data may be sent to the second communication unit 23 of the second remote control device 20. The audio data may be encrypted during packet processing. Further, the second communication unit 23 may receive the audio data sent by the first communication unit 13 and then send the audio data to the second data processing unit 22. The second data processing unit 22 may parse the audio data and send the parsed audio data to the second output module. The audio corresponding to the audio data may then be played using the second output module. As such, transmission of the audio data from the first remote control device 10 to the second remote control device 20 may be achieved. The second communication unit 23 may further verify the audio data when receiving the audio data. When the audio data is encrypted, the second data processing unit 22 may further perform a decryption operation on the audio data while parsing the audio data.

The process of sending the audio data from the second remote control device 20 to the first remote control device may be the reverse of the process described above, and the details are not described herein again.

For interactive data such as text data, image data, video data, or operation data, the transmission process may be similar to the transmission of audio data, and the difference may include that the first data processing unit 12 may need to define the corresponding data format process when performing packet processing on different types of interactive data.

According to the UAV system provided by various embodiments of the present disclosure, two remote control devices directly communicate with each other to form a communication link, and through the communication link, the two remote control devices are able to directly exchange the interactive data, thereby realizing real-time two-way communication between the two remote control devices. As such, influence on the remote control signal may not be affected, and the security and privacy of data transmission may be ensured. In addition, third-party applications of mobile devices based on cellular data communication may not be necessary, thereby avoiding additional costs, and reducing the complexity of the UAV system. As such, even when the signal of the cellular data communication is poor, real-time two-way communication between two remote control devices may still be achieved.

The present disclosure also provides a communication method according to the disclosed UAV system. FIG. 5 illustrates a schematic flowchart of an exemplary communication method of a UAV system according to various embodiments of the present disclosure. Referring to FIG. 5, the communication method may include the followings.

In S10, a communication connection may be established between a first remote control device and a UAV; a communication connection may be established between a second remote control device and a functional device mounted on the UAV; and a communication connection may be established between the first remote control device and the second remote control device, where the first remote control device may send remote control information to control the UAV, the second remote control device may send remote control information to control the functional device.

In S20, the first remote control device may send interactive data to the second remote control device, and may receive interactive data sent by the second remote control device.

In one embodiment, the interactive data may at least include text data or audio data. For example, the interactive data may include one or more types of text data, graphic data, audio data, video data, and operation data. It should be noted that the communication frequency band that the first remote control device and the second remote control device use to send remote control information may be different from the communication frequency band that the first remote control device and the second remote control device use to exchange interactive data. For example, the first remote control device 10 and the second remote control device 20 may operate in a communication frequency band corresponding to 2.4 GHz when sending remote control information, and the first remote control device 10 and the second remote control device 20 may operate in a communication frequency band corresponding to 5.8 GHz when sending and receiving interactive data. Alternatively, the first remote control device 10 and the second remote control device 20 may operate in a communication frequency band corresponding to 5.8 GHz when sending remote control information, and the first remote control device 10 and the second remote control device 20 may operate in a communication frequency band corresponding to 2.4 GHz when sending and receiving interactive data.

In one embodiment of the present disclosure, the first remote control device sending the interactive data to the second remote control device and receiving the interactive data sent by the second remote control device may include the following operations.

After collecting the interactive data, the first remote control device may perform packet processing on the interactive data, and then send the packet-processed interactive data to the second remote control device. After receiving the interactive data sent by the second remote control device, the first remote control device may parse the received interactive data and output the parsed interactive data. The content included in the packet-processed interactive data may referred to the corresponding description in the embodiments provided above, and the details are not described herein again.

In some embodiments, when the first remote control device receives the interactive data sent by the second remote control device, the method may further include: the first remote control device checking the received interactive data to ensure the accuracy and completeness of the received data.

In some embodiments of the present disclosure, performing packet processing on the collected interactive data may include encrypting the collected interactive data. Further, parsing the received interactive data may include decrypting the received interactive data. By encrypting the interactive data, the security and privacy of data transmission may be further ensured.

In some embodiments of the present disclosure, sending the packet-processed interactive data to the second remote control device may include: the first remote control device may identify a recipient of the packet-processed interactive data, and when the identified recipient is the second remote control device, the packet-processed interactive data may be sent to the second remote control device. As such, when there are multiple recipients, information can be directed to any one of the recipients.

In some embodiments of the present disclosure, the method may further include forming a communication link by communicatively connecting the first remote control device, the controlled device, and the second remote control device in sequence. The controlled device may include a UAV and/or a functional device mounted on the UAV; the first remote control device may send interactive data to the second remote control device through the controlled device, and may receive the interactive data sent by the second remote control device through the controlled device. As such, the UAV may be used as a relay communication station to realize mutual exchange of the interactive data between the first remote control device and the second remote control device.

According to the communication method of the UAV system provided by various embodiments of the present disclosure, real-time two-way communication between the two remote control devices of the UAV may be realized without affecting the remote control signal, and the security and privacy of data transmission may also be ensured. In the meantime, third-party applications of mobile devices based on cellular data communication may not be necessary, and thus additional costs may be avoided, and the complexity of the UAV system may be reduced. As such, even when the signal of the cellular data communication is poor, real-time two-way communication between the two remote control devices may still be achieved.

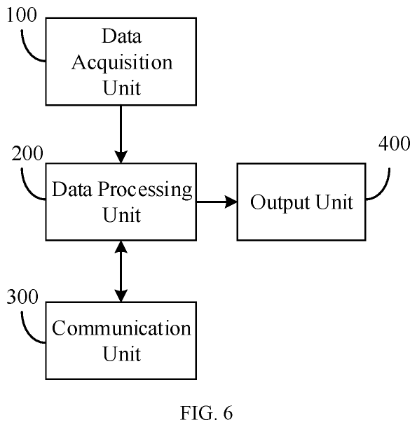

The present disclosure also provides a remote control device, applied to the UAV system described in various embodiments of the present disclosure. FIG. 6 illustrates a structural block diagram of an exemplary remote control device according to various embodiments of the present disclosure. Referring to FIG. 6, the remote control device may include a data acquisition unit 100, a data processing unit 200, a communication unit 300, and an output unit 400. The remote control device may communicate with another remote control device through a communication unit.

The data acquisition unit 100 may be configured to collect interactive data and send the collected interactive data to the data processing unit 200. The interactive data may at least include text data or audio data. In one embodiment, the interactive data collected by the data acquisition unit 100 may include one or more types of text data, graphic data, audio data, video data, and operation data. In one embodiment, the collected interactive data may also be sent to a storage unit (not shown) of the remote control device for backup storage.

The data processing unit may be configured to perform packet processing on the interactive data collected by the data acquisition unit 100, and send the packet-processed interactive data to the communication unit 300. The content included in the packet-processed interactive data may referred to the corresponding description in the embodiments provided above, and the details are not described herein again.

The communication unit 300 may be configured to send the interactive data, packet-processed by the data processing unit 200, to another remote control device. In one embodiment, the communication unit 300 may be a wireless communication module, such as a Wi-Fi module.

The communication unit 300 may be further configured to receive the interactive data sent by another remote control device. In one embodiment, when receiving the interactive data sent by another remote control device, the communication unit 300 may verify the received interactive data to ensure the accuracy and completeness of the received interactive data.

The data processing unit 200 may further be configured to parse the interactive data received by the communication unit 300.

The output unit 400 may be configured to output the interactive data parsed by the data processing unit 200. For example, the output unit 400 may output the interactive data in a form of audio playback or visual display.

The remote control device may be a remote controller with an interactive interface and an operation handle, a mobile terminal with an interactive interface, or a combination of a mobile terminal with an interactive interface and a remote controller with an operation handle. The mobile terminal with an interactive interface may be a mobile phone, a tablet computer, or any other mobile electronic device with a communication module.

In one embodiment, the remote control device may be a combination of a mobile terminal with an interactive interface and a remote controller with an operation handle. The mobile terminal and the remote controller may be connected wirelessly or may be connected through a USB, and the two remote controllers may be connected via Wi-Fi.

Further, when the remote control device is a combination of a mobile terminal with an interactive interface and a remote controller with an operation handle, the mobile terminal may include the data acquisition unit 100 while the remote controller may include the data processing unit 200 and the communication unit 300, and the interactive data collected by the mobile terminal may be transparently sent to the remote controller for further operations. Alternatively, the mobile terminal may include the data acquisition unit 100 and the data processing unit 200 while the remote controller may include the communication unit 300, and the mobile terminal may collect interactive data and process the data, and then transparently send the data to the remote controller for further operations. The output unit 400 may be disposed on the mobile terminal, on the remote controller, or on both the mobile terminal and remote controller.

Further, in various embodiments of the present disclosure, the data acquisition unit 100 may be a camera device and/or a voice acquisition device such as a microphone; the output unit 400 may be a speaker, a display device, or a combination of a speaker and a display device, and may display pictures, text, interface operations, and play audio and video. In various embodiments of the present disclosure, the data processing unit 200 may be further configured to perform an encryption operation on the interactive data collected by the data acquisition unit 100 and a decryption operation on the interactive data received by the communication unit 300. By encrypting the interactive data, the security and privacy of data transmission may be further ensured.

In some embodiments of the present disclosure, the communication unit 300 may be further configured to identify a recipient of the interactive data, packet-processed by the data processing unit 200, and when the identified recipient is another remote control device, send the interactive data, packet-processed by the data processing unit 200, to the other remote control device. When there are multiple recipients, by identifying the recipients, directed data transmission may be realized.

In various embodiments of the present disclosure, the communication unit 300 may be further configured to send the interactive data, packet-processed by the data processing unit 200, to another remote control device through a controlled device, and receive the interactive data sent by the other remote control device through the controlled device. The controlled device may be a UAV and/or a functional device mounted on the UAV. The communication unit 300 may send the interactive data to the controlled device. After identifying the recipient of the interactive data, the controlled device may send the interactive data to the identified recipient. The interactive data may be sent separately from the remote control information. Alternatively, the interactive data may be included in the remote control information and sent to the controlled device together. The controlled device may read the interactive data included in the remote control information and send the interactive data to the identified recipient. As such, the controlled device may be used as a relay communication station to realize mutual exchange of the interactive data between the remote control device and another remote control device.

According to the remote control device provided by various embodiments of the present disclosure, in a UAV system using dual remote control devices, real-time two-way communication between the two remote control devices of the UAV may be realized without affecting the remote control signal, and the security and privacy of data transmission may also be ensured. In the meantime, third-party applications of mobile devices based on cellular data communication may not be necessary, and thus additional costs may be avoided, and the complexity of the UAV system may be reduced. As such, even when the signal of the cellular data communication is poor, real-time two-way communication between two remote control devices may still be achieved.

It should be noted that the functional modules in various embodiments of the present disclosure may be integrated into one processing unit, or each of the modules may exist separately physically, or two or more modules may be integrated into one unit. The integrated unit described above may be implemented in the form of hardware, or in the form of hardware combined with software functional units.

The above integrated unit implemented in the form of software functional units may be stored in a computer-readable storage medium. The software functional units stored in a storage medium may include a plurality of instructions for making a computer device (which may be a personal computer, a server, or a network device) or an intelligent terminal device or a processor execute part of the steps of the method according to various embodiments of the present invention. The storage media described above may include: a U disk, a mobile hard disk, a read-only memory (ROM), a random access memory (RAM), a magnetic disk, a compact discs, and/or other media that can store program code.

In the various embodiments provided by the present application, it should be understood that the disclosed systems, devices, and methods may be implemented in other manners. For example, the device embodiments described above are merely illustrative. For instance, in various embodiments of the present disclosure, the units are divided or defined merely according to the logical functions of the units, and in actual applications, the units may be divided or defined in another manner. For example, multiple units or components may be combined or integrated into another system, or some features can be ignored or not executed. In addition, the mutual coupling or direct coupling or communication connection shown or discussed may be an indirect coupling or communication connection through some interface, device or unit, and may be in an electrical, mechanical, or other form.

The units described as separate components may or may not be physically separated, and the components displayed as a unit may or may not be physical in a unit, that is, they may be located in one place, or may be distributed to multiple network units. Some or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

Finally, it should be noted that the above embodiments are merely illustrative of, but not intended to limit, the technical solutions of the present disclosure; although the present disclosure has been described in detail with reference to the above embodiments, those skilled in the art should understand that the technical solutions described in the above embodiments may be modified, or part or all of the technical features may be equivalently replaced; and the modifications or substitutions do not depart from the scope of the technical solutions of various embodiments of the present disclosure.

What is claimed is:

1. An unmanned aerial vehicle (UAV) system, comprising:
a first remote control device;
a second remote control device;
a UAV; and
a functional device mounted on the UAV,
wherein:
the first remote control device is configured to send remote control information to control the UAV;
the second remote control device is configured to send remote control information to control the functional device;
the first remote control device and the second remote control device are communicatively connected to form a communication link; and
the first remote control device and the second remote control device exchange interactive data based on the communication link, wherein the interactive data at least include text data or audio data.

2. The UAV system according to claim 1, wherein:
the first remote control device includes a first data acquisition unit, a first data processing unit, a first communication unit, and a first output unit;
the first data acquisition unit is configured to collect the interactive data, the first data processing unit is configured to perform packet processing on the interactive data collected by the first data acquisition unit, and the first communication unit is configured to send the interactive data, packet-processed by the first data processing unit, to the second remote control device; and
the first communication unit is further configured to receive interactive data sent by the second remote control device, the first data processing unit is further configured to parse the interactive data received by the first communication unit, and the first output unit is configured to output the interactive data parsed by the first data processing unit.

3. The UAV system according to claim 2, wherein:
the first data processing unit is further configured to perform an encryption operation on the interactive data collected by the first data acquisition unit and a decryption operation on the interactive data received by the first communication unit.

4. The UAV system according to claim 2, wherein:
the first communication unit is further configured to identify a recipient of the interactive data, packet-processed by the first data processing unit; and when the identified recipient is the second remote control device, send the interactive data, packet-processed by the first data processing unit, to the second remote control device.

5. The UAV system according to claim 2, wherein:
the first data acquisition unit is at least one of a camera device and a voice acquisition device.

6. The UAV system according to claim 2, wherein:
the first output unit is a speaker, a display device, or a combination of a speaker and a display device.

7. The UAV system according to claim 1, wherein:
the second remote control device includes a second data acquisition unit, a second data processing unit, a second communication unit, and a second output unit;
the second data acquisition unit is configured to collect the interactive data, the second data processing unit is configured to perform packet processing on the interactive data collected by the second data acquisition unit, and the second communication unit is configured to send the interactive data, packet-processed by the second data processing unit, to the first remote control device; and
the second communication unit is further configured to receive interactive data sent by the first remote control device, the second data processing unit is further configured to parse the interactive data received by the second communication unit, and the second output unit is configured to output the interactive data parsed by the second data processing unit.

8. The UAV system according to claim 7, wherein:
the second data processing unit is further configured to perform an encryption operation on the interactive data collected by the second data acquisition unit and a decryption operation on the interactive data received by the second communication unit.

9. The UAV system according to claim 7, wherein:
the second communication unit is further configured to identify a recipient of the interactive data, packet-processed by the second data processing unit; and when the identified recipient is the first remote control device, send the interactive data, packet-processed by the second data processing unit, to the first remote control device.

10. The UAV system according to claim 7, wherein:
the second data acquisition unit is at least one of a camera device and a voice acquisition device.

11. The UAV system according to claim 7, wherein:
the second output unit is a speaker, a display device, or a combination of a speaker and a display device.

12. The UAV system according to claim 1, wherein:
the first remote control device, a controlled device, and the second remote control device are communicatively connected in sequence to form another communication link;
the controlled device includes at least one of the UAV or the functional device; and
the first remote control device and the second remote control device are capable of exchanging interactive data based on the another communication link.

13. The UAV system according to claim 1, wherein each of the first remote control device and the second remote control device is one of:
a remote controlled with an interactive interface and an operation handle;
a mobile terminal with an interactive interface; and
a combination of a mobile terminal with an interactive interface and a remote controller with an operation handle.

14. The UAV system according to claim 1, wherein:
the functional device is at least one of a gimbal, a camera, a spraying device, and an environmental monitoring device.

15. The UAV system according to claim 1, wherein:
the UAV is one of an unmanned aircraft, an unmanned ship, and an unmanned vehicle.

16. A communication method for a UAV system including a first remote control device, a second remote control device, a UAV, and a functional device mounted on the UAV, comprising:
establishing a first communication connection between the first remote control device and the UAV, establishing a second communication connection between the second remote control device and the functional device, and establishing a third communication connection between the first remote control device and the second remote control device;
sending, by the first remote control device, remote control information via the first communication connection to control the UAV;
sending, by the second remote control device, remote control information via the second communication connection to control the functional device; and
sending and receiving, by the first remote control device, interactive data to and from the second remote control device, wherein the interactive data includes at least one type of text data or video data.

17. The communication method according to claim 16, wherein sending and receiving, by the first remote control device, the interactive data to and from the second remote control device includes:
after collecting, by the first remote control device, the interactive data, performing packet processing on the collected interactive data, and sending the packet-processed interactive data to the second remote control device; and
after receiving, by the first remote control device, the interactive data sent by the second remote control device, parsing the received interactive data, and outputting the parsed interactive data.

18. The communication method according to claim 16, further including:
communicatively connecting the first remote control device, a controlled device, and a second remote control device in sequence to form a communication link, wherein:
the controlled device includes at least one of the UAV or the functional device mounted on the UAV; and
the first remote control device sends and receives the interactive data to and from the second remote control device through the controlled device.

19. A remote control device for a UAV system, comprising a data acquisition unit, a data processing unit, a communication unit, and an output unit, wherein:
the remote control device communicates with another remote control device through the communication unit;
the data acquisition unit is configured to collect interactive data, the interactive data including at least one type of text data or video data, the data processing unit is configured to perform packet processing on the interactive data collected by the data acquisition unit, and the communication unit is configured to send the interactive data, packet-processed by the data processing unit, to the another remote control device; and
the communication unit is further configured to receive interactive data sent by the another remote control device, the data processing unit is further configured to parse the interactive data received by the communication unit, and the output unit is configured to output the interactive data parsed by the data processing unit.

20. The remote control device according to claim 19, wherein the remote control device is one of:
a remote controlled with an interactive interface and an operation handle;
a mobile terminal with an interactive interface; and
a combination of a mobile terminal with an interactive interface and a remote controller with an operation handle.
